(19) United States
(12) Patent Application Publication
(10) Pub. No.: US 2021/0266872 A1
(43) Pub. Date: Aug. 26, 2021

(54) METHOD AND APPARATUS USED IN WLAN NETWORKS

(71) Applicant: Intel Corporation, Santa Clara, CA (US)

(72) Inventors: Xiaogang CHEN, Portland, OR (US); Laurent CARIOU, Millizac (FR); Po-Kai HUANG, San Jose, CA (US); Thomas KENNEY, Portland, OR (US); Qinghua LI, San Ramon, CA (US)

(73) Assignee: Intel Corporation, Santa Clara, CA (US)

(21) Appl. No.: 17/317,930

(22) Filed: May 12, 2021

(51) Int. Cl. H04W 72/04

(52) U.S. Cl. CPC H04W 72/04; H04W 84/12

(57) ABSTRACT

The disclosure provides a method for an Access Point (AP), including: encoding a trigger frame in a parameterized spatial reuse reception (PSRR) physical layer (PHY) protocol data unit (PSRR PPDU); and providing the PSRR PPDU for transmission to one or more Stations (STAs), wherein the PSRR PPDU comprising puncture information indicating punctured subchannels of the PSRR PPDU or a normalization factor indicating a number of subchannels occupied by the PSRR PPDU.

### TECHNICAL FIELD

Embodiments of the present disclosure generally relate to wireless communications in a wireless local area network (WLAN), and in particular, to a method and apparatus used in a WLAN.

### BACKGROUND

New generation communication protocols (e.g. Institute of Electrical and Electronic Engineers (IEEE) 802.11be) for the Wireless Local Access Network (WLAN) have defined a very large Physical Protocol Data Unit (PPDU) bandwidth (e.g. up to 320 MHz), while in the previous generation communication protocols (e.g. IEEE 802.11ax) for the WLAN, the maximum PPDU bandwidth is 160 MHz. Additionally, the new generation communication protocols for the WLAN may introduce punctured operations where some subchannels within the total bandwidth of the PPDU may not be used.

Parameterized Spatial reuse (PSR) based Spatial Reuse (SR) procedure is defined in the previous generation communication protocols. The PSR-based SR procedure allows, based on Spatial Reuse Parameter Set element, the medium to be reused more often between overlapping basic service sets (OBSSs) in dense deployment scenarios. The PSR-based SR procedure is related to the calculation of a Received Power Level (RPL). Previous generation communication protocols (e.g. IEEE 802.11ax) for the WLAN define rules for the RPL calculation, as described in 26.10.3.2 (PSR-based spatial reuse initiation) in IEEE 802.11ax D6.0. Specifically, the RPL is calculated by normalizing over 20 MHz subchannels instead of the total bandwidth, which assumes that a STA (e.g., a non-Access Point (AP) STA) receiving the PSRR PPDU knows how many 20 MHz subchannels are available in a received Parameterized Spatial Reuse Reception (PSRR) PPDU from an AP. This is not a valid assumption since in subchannel punctured cases, some subchannels within the total bandwidth of the PPDU may not be used, the calculation of the RPL should be based on the 20 MHz subchannels actually occupied by the PSRR PPDU but not the total bandwidth, but the information of the occupied subchannels is not known by the STA.

### BRIEF DESCRIPTION OF THE DRAWINGS

The various advantages of the embodiments will become apparent to one skilled in the art by reading the following specification and appended claims, and by referencing the following drawings, in which:

FIG. 1 is a flowchart showing a method 100 for an AP according to some embodiments of the disclosure.

FIG. 2 is a diagram showing an exemplary common information field format in PSRR PPDU according to some embodiments of the disclosure;

FIG. 3 is a diagram showing an exemplary special user information field format in PSRR PPDU according to some embodiments of the disclosure;

FIG. 4 is a flowchart showing a method 400 for a STA according to some embodiments of the disclosure.

FIG. 5 is a diagram showing an exemplary format of TB PPDU according to some embodiments of the disclosure;

FIG. 6 is a diagram showing a STA information field of a NDP announcement frame;

FIG. 7 shows a functional diagram of an exemplary communication device according to some embodiments of the present disclosure;

FIG. 8 shows a block diagram of an example of a machine or system upon which any one or more of the techniques discussed herein may be performed, according to some embodiments of the present disclosure;

FIG. 9 is a block diagram of a radio architecture according to some embodiments of the present disclosure;

FIG. 10 is a functional block diagram illustrating the WLAN FEM circuitry of FIG. 9, according to some embodiments of the present disclosure;

FIG. 11 is a functional block diagram illustrating the radio IC circuitry of FIG. 9, according to some embodiments of the present disclosure; and

FIG. 12 is a functional block diagram illustrating the baseband processing circuitry of FIG. 9, according to some embodiments of the present disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

In order to allow for the increased PPDU bandwidth and the punctured operations defined in the new generation communication protocols (e.g., IEEE 802.11be), the existing PSR-based SR procedure may need to be improved. In the present disclosure, it is proposed to include, in a PSRR PPDU or a TB PPDU (e.g., an EHT PSRR PPDU or an EHT TB PPDU), puncture information or a normalization factor of the PPDU, so as to make PSR-based SR procedure more accurate and easier.

According to some embodiments of the present disclosure, an Access Point (AP) may generate and transmit a trigger frame in a PSRR PPDU to one or more STAs. The PSRR PPDU is a PPDU that contains a Trigger frame that has a value in the UL Spatial Reuse subfield of the Common Info field that is neither PSR_DISALLOW nor PSR_AND_NON_SRG_OBSS_PD_PROHIBITED.

According to some embodiments of the present disclosure, a station (STA) may generate and transmit a TB PPDU, in response to receiving a trigger frame from an AP, to the AP. The STAs may be mobile devices that are non-stationary (e.g., not having fixed locations) or may be stationary devices.

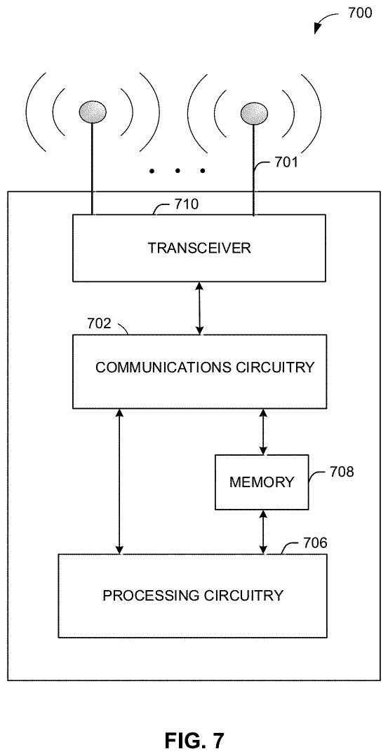

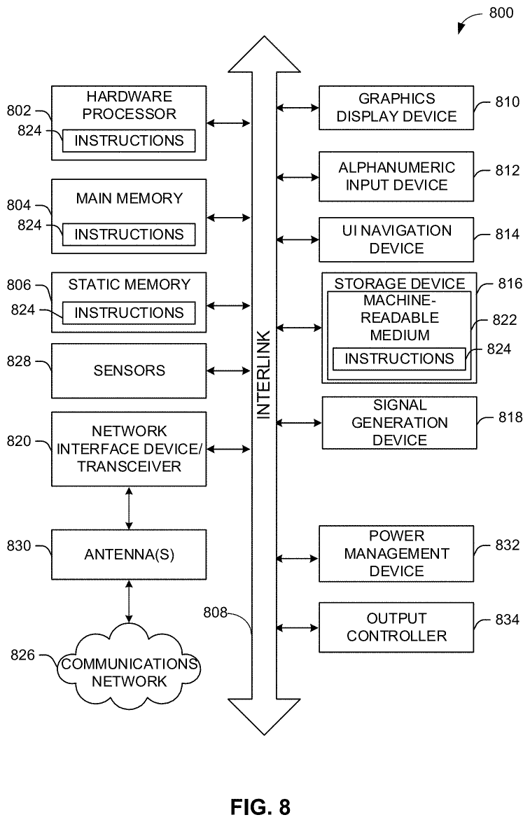

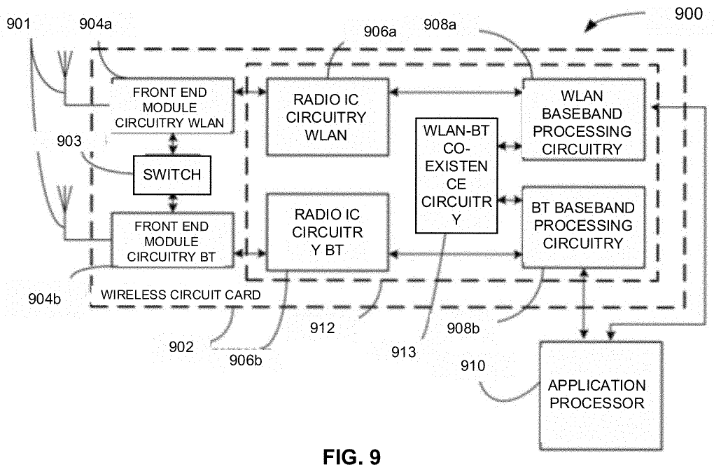

In some embodiments, the AP and the STA may include one or more function modules similar to those in the functional diagram of FIG. 7 and/or the example machine/system of FIG. 8 or FIG. 9.

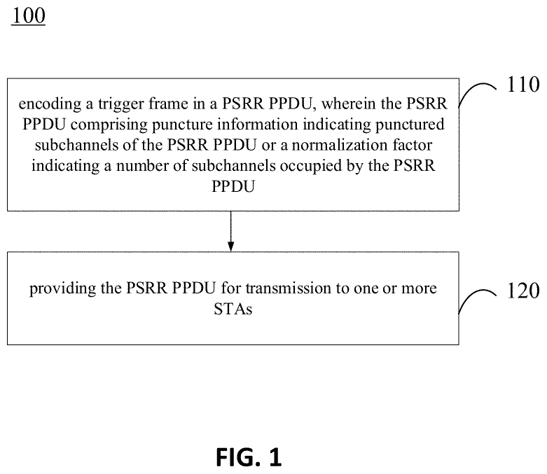

FIG. 1 is a flowchart showing a method 100 for an AP according to some embodiments of the disclosure. As shown in FIG. 1, the method 100 may include: S110, encoding a trigger frame in a PSRR PPDU, wherein the PSRR PPDU comprising puncture information indicating punctured subchannels of the PSRR PPDU or a normalization factor indicating a number of subchannels occupied by the PSRR PPDU; and S120, providing the PSRR PPDU for transmission to one or more STAs.

In the method 100, after receiving and decoding the trigger frame in the PSRR PPDU including the puncture information or the normalization factor, the one or more STA can obtain the puncture information or the normalization factor from the trigger frame directly. After obtaining the puncture information or the normalization factor, the one or more STA can perform UL transmission based on PSR-based SR.

In some embodiments, the trigger frame may include a common information field and a special user information field, and the puncture information or the normalization factor may be carried in the common information field and/or the special user information field.

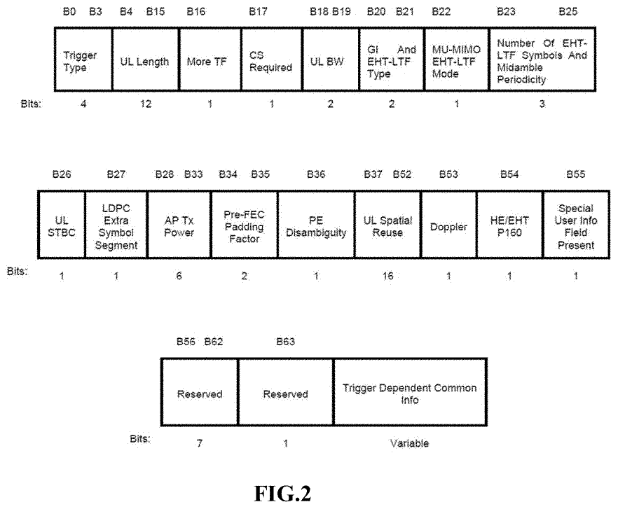

FIG. 2 is a diagram showing an exemplary common information field format in PSRR PPDU (e.g., EHT PSRR PPDU) according to some embodiments of the disclosure. As shown in FIG. 2, the common information field may include a first reserved subfield of 7 bits and a second reserved subfield of 1 bit.

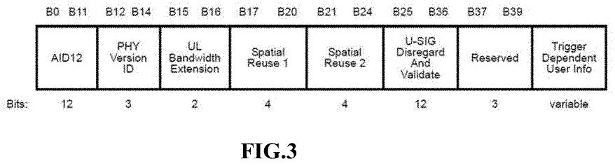

FIG. 3 is a diagram showing an exemplary special user information field format in PSRR PPDU (e.g., EHT PSRR PPDU) according to some embodiments of the disclosure. As shown in FIG. 3, the special user information field may include a U-SIG Disregard and Validate subfield of 12 bits and a reserved subfield of 3 bits.

In some embodiments, the PSRR PPDU may employ the common information field format shown in FIG. 2 and the special user information field format shown in FIG. 3.

In some embodiments, if the puncture information is carried in the PSRR PPDU, the puncture information may indicate the position of a punctured subchannel within the PSRR PPDU, and the puncture information may be carried in a plurality of bits in the PSRR PPDU, for example, in 9 bits.

It should be appreciated that depending on the development of the PPDU bandwidth in the WLAN network, the puncture information may be carried in more bits.

In some embodiments, the puncture information may be contained within the reserved subfields of the common information field and the reserved subfield of the special user information field. For example, the puncture information may be carried in 8 reserved bits B56-B63 of the common information field as shown in FIG. 2 and 1 reserved bit of the special user information field as shown in FIG. 3.

In some embodiments, the puncture information may be contained within the U-SIG Disregard and Validate subfield and the reserved subfield of the special user information field. For example, the puncture information may be carried in any 9 bits of B25-B30 and B32-B39 of the special user information field.

In some embodiments, an additional special user information field right after the current special user information field may be defined for the PSRR PPDU. The presence of the second special user information field may be the same as the presence of the current special user information field. The size of the second special user information field may be the same as the current special user information field in the PSRR PPDU. The format of the second special user information field may be the same as the current special user information field, as shown in FIG. 3.

In some embodiments, the puncture information may be carried in the additional special user information field. For example, the puncture information may be carried in the additional special user information field in a same way with the current special user information field.

In some embodiments, the normalization factor is carried, it may be used to indicate the number of normalization (1-16) which means 4 bits are needed. The reason of 4 bits are needed is 320 MHz PPDU has 16 subchannels each of which is 20 MHz. The signaling of normalization factor need to indicate how many subchannels out of 16 is occupied.

It should be appreciated that depending on the development of the PPDU bandwidth in the WLAN network, the normalization factor may be carried in more bits.

In some embodiments, the normalization factor may be carried in the common information field in the PSRR PPDU as shown in FIG. 2. In some embodiments, the normalization factor may be carried in any 4 bits of B56-B62 of the first reserved subfield in the common information field, for example, the normalization factor may be carried in bits of B56-B59.

In some embodiments, the normalization factor may be carried in the special user information field in the PSRR PPDU as shown in FIG. 3. In some embodiments, the normalization factor may be carried in any 4 bits of B25-B30 or B32-B39 of the special user info field, for example, the normalization factor may be carried in bits of B25-B28 or B32-B35.

It should be appreciated that the method 100 may be implemented in WLANs complying with IEEE 802.11 standards including IEEE 802.11be. In one embodiment, the PSRR PPDU may be an Extremely High Throughput (EHT) PSRR PPDU, or any PSRR PPDU to which the principle of the present application may be applied, for example, a next-generation PSRR PPDU.

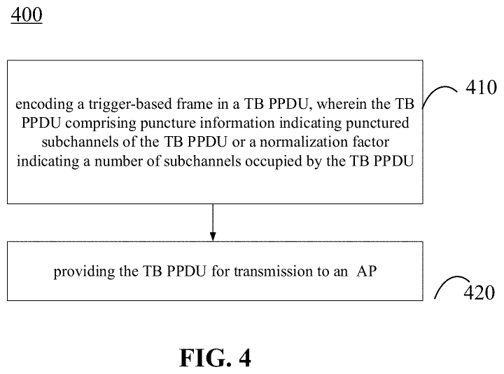

FIG. 4 is a flowchart showing a method 400 for a STA according to some embodiments of the disclosure. As shown in FIG. 4, the method 400 includes: S410, encoding a trigger-based frame in a Trigger Based (TB) PPDU, wherein the TB PPDU comprises puncture information indicating punctured subchannels of the TB PPDU or a normalization factor indicating a number of subchannels occupied by the TB PPDU; S420, providing the TB PPDU for transmission to an AP.

In some embodiments, the normalization factor is carried in the TB PPDU, the normalization factor may be encoded in, for example, 4 bits, to indicate number 1 to number 16 by a binary value.

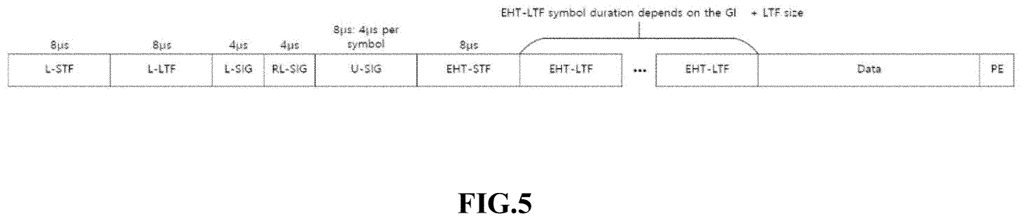

FIG. 5 is a diagram showing an exemplary format of TB PPDU (e.g., EHT TB PPDU) according to some embodiments of the disclosure. As shown in FIG. 5, the TB PPDU may include a U-SIG field. Table 1 shows the U-SIG field of an EHT TB PPDU. As shown in Table 1, the U-SIG field may include a U-SIG-1 subfield and a U-SIG-2 subfield.

TABLE 1
U-SIG field of an EHT TB PPDU

| Two parts | | | Number |
|---|---|---|---|
| of U-SIG | Bit | Field | of bits |
| U-SIG-1 | B0-B2 | Version Identifier | 3 |
| | B3-B5 | BW | 3 |
| | B6 | UL/DL | 1 |
| | B7-B12 | BSS Color | 6 |
| | B13-B19 | TXOP | 7 |
| | B20-B25 | Disregard | 6 |
| U-SIG-2 | B0-B1 | PPDU Type And | 2 |
| | | Compressed Mode | |
| | B2 | Validate | 1 |
| | B3-B6 | Spatial Reuse 1 | 4 |
| | B7-B10 | Spatial Reuse 2 | 4 |
| | B11-B15 | Disregard | 5 |
| | B16-B19 | CRC | 4 |
| | B20-B25 | Tail | 6 |

In some embodiments, the normalization factor may be carried in the U-SIG field of the TB PPDU. In some embodiments, the normalization factor may be carried in any 4 bits of B20-B25 in U-SIG-1 or B11-B15 in U-SIG-2, as shown in Table 1.

In some embodiments, the puncture information may be carried in the TB PPDU, for example, the puncture information may be encoded in a same manner with partial bandwidth information encoded in a NDP announcement frame.

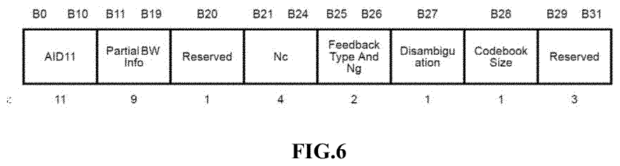

The NDP announcement frame may include a partial BW info subfield in a STA information field. FIG. 6 is a diagram showing a STA information field of the NDP announcement frame. As shown FIG. 6, the STA info field of the NDP announcement frame includes 9 bits of B11-B19 to show partial bandwidth information. The 9 bits of puncture information may be encoded in the TB PPDU in a same way as the 9 bits partial bandwidth information of B11-B19 encoded in the NDP announcement frame, as shown in Section 9.3.1.19 (VHT/HE/EHT NDP Announcement frame format) in IEEE 802.11be.

It should be appreciated that the method 400 may be implemented in WLANs complying with IEEE 802.11 standards including IEEE 802.11be. In one embodiment, the TB PPDU may be an Extremely High Throughput (EHT) TB PPDU, or any TB PPDU to which the principle of the present application may be applied, for example, a next-generation TB PPDU.

More particularly, the process 100 of FIG. 1 or the process 400 of FIG. 4 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the process 100 of FIG. 1 or the process 400 of FIG. 4 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 7 shows a functional diagram of an exemplary communication device 700, in accordance with one or more example embodiments of the disclosure. In one embodiment, FIG. 7 illustrates a functional block diagram of a communication device that may be suitable for use as the AP(s) or the STA(s) in accordance with some embodiments. The communication device 700 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication device 700 may include communications circuitry 702 and a transceiver 710 for transmitting and receiving signals to and from other communication stations using one or more antennas 701. The communications circuitry 702 may include circuitry that can operate the physical layer (PHY) communications and/or medium access control (MAC) communications for controlling access to the wireless medium, and/or any other communications layers for transmitting and receiving signals. The communication device 700 may also include processing circuitry 706 and memory 708 arranged to perform the operations described herein. In some embodiments, the communications circuitry 702 and the processing circuitry 706 may be configured to perform operations detailed in the above figures, diagrams, and flows.

In accordance with some embodiments, the communications circuitry 702 may be arranged to contend for a wireless medium and configure frames or packets for communicating over the wireless medium. The communications circuitry 702 may be arranged to transmit and receive signals. The communications circuitry 702 may also include circuitry for modulation/demodulation, upconversion/downconversion, filtering, amplification, etc. In some embodiments, the processing circuitry 706 of the communication device 700 may include one or more processors. In other embodiments, two or more antennas 701 may be coupled to the communications circuitry 702 arranged for transmitting and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device, read-only memory (ROM), random-access memory (RAM), magnetic disk storage media, optical storage media, flash-memory devices and other storage devices and media.

In some embodiments, the communication device 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication device 700 may include one or more antennas 701. The antennas 701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication device 700 may include one or more of a keyboard, a display, a non-volatile memory port, multiple antennas, a graphics processor, an application processor, speakers, and other mobile device elements. The display may be a liquid crystal display (LCD) screen including a touch screen.

Although the communication device 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication device 700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication device 700 may include one or more processors and may be configured with instructions stored on a computer-readable storage device.

FIG. 8 illustrates a block diagram of an example of a machine 800 upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a speaker), a network interface device/transceiver 820 coupled to antenna(s) 830, and one or more sensors 828, such as a global positioning system (GPS) sensor, a compass, an accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the disclosure may be carried out by a baseband processor. The baseband processor may be configured to generate corresponding baseband signals. The baseband processor may further include physical layer (PHY) and medium access control layer (MAC) circuitry, and may further interface with the hardware processor 802 for generation and processing of the baseband signals and for controlling operations of the main memory 804, and/or the storage device 816. The baseband processor may be provided on a single radio card, a single chip, or an integrated circuit (IC).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 800 and that cause the machine 800 to perform any one or more of the techniques of the disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The instructions may implement one or more aspects of the methods/processes described above, including the operations of FIG. 1 and the operations of FIG. 4 as described herein.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

FIG. 9 is a block diagram of a radio architecture 900 in accordance with some embodiments. The radio architecture 900 may be implemented in any of the AP(s) and/or STA(s). Radio architecture 900 may include radio front-end module (FEM) circuitry 904a-b, radio IC circuitry 906a-b and baseband processing circuitry 908a-b. Radio architecture 900 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 904a-b may include a WLAN or Wi-Fi FEM circuitry 904a and a Bluetooth (BT) FEM circuitry 904b. The WLAN FEM circuitry 904a may include a receive signal path comprising circuitry configured to operate on WLAN RF signals received from one or more antennas 901, to amplify the received signals and to provide the amplified versions of the received signals to the WLAN radio IC circuitry 906a for further processing. The BT FEM circuitry 904b may include a receive signal path which may include circuitry configured to operate on BT RF signals received from one or more antennas 901, to amplify the received signals and to provide the amplified versions of the received signals to the BT radio IC circuitry 906b for further processing. FEM circuitry 904a may also include a transmit signal path which may include circuitry configured to amplify WLAN signals provided by the radio IC circuitry 906a for wireless transmission by one or more of the antennas 901. In addition, FEM circuitry 904b may also include a transmit signal path which may include circuitry configured to amplify BT signals provided by the radio IC circuitry 906b for wireless transmission by the one or more antennas. In the embodiment of FIG. 9, although FEM 904a and FEM 904b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 906a-b as shown may include WLAN radio IC circuitry 906a and BT radio IC circuitry 906b. The WLAN radio IC circuitry 906a may include a receive signal path which may include circuitry to down-convert WLAN RF signals received from the FEM circuitry 904a and provide baseband signals to WLAN baseband processing circuitry 908a. BT radio IC circuitry 906b may in turn include a receive signal path which may include circuitry to down-convert BT RF signals received from the FEM circuitry 904b and provide baseband signals to BT baseband processing circuitry 908b. WLAN radio IC circuitry 906a may also include a transmit signal path which may include circuitry to up-convert WLAN baseband signals provided by the WLAN baseband processing circuitry 908a and provide WLAN RF output signals to the FEM circuitry 904a for subsequent wireless transmission by the one or more antennas 901. BT radio IC circuitry 906b may also include a transmit signal path which may include circuitry to up-convert BT baseband signals provided by the BT baseband processing circuitry 908b and provide BT RF output signals to the FEM circuitry 904b for subsequent wireless transmission by the one or more antennas 901. In the embodiment of FIG. 9, although radio IC circuitries 906a and 906b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 908a-b may include a WLAN baseband processing circuitry 908a and a BT baseband processing circuitry 908b. The WLAN baseband processing circuitry 908a may include a memory, such as, for example, a set of RAM arrays in a Fast Fourier Transform or Inverse Fast Fourier Transform block (not shown) of the WLAN baseband processing circuitry 908a. Each of the WLAN baseband circuitry 908a and the BT baseband circuitry 908b may further include one or more processors and control logic to process the signals received from the corresponding WLAN or BT receive signal path of the radio IC circuitry 906a-b, and to also generate corresponding WLAN or BT baseband signals for the transmit signal path of the radio IC circuitry 906a-b. Each of the baseband processing circuitries 908a and 908b may further include physical layer (PHY) and medium access control layer (MAC) circuitry, and may further interface with a device for generation and processing of the baseband signals and for controlling operations of the radio IC circuitry 906a-b.

Referring still to FIG. 9, according to the shown embodiment, WLAN-BT coexistence circuitry 913 may include logic providing an interface between the WLAN baseband circuitry 908a and the BT baseband circuitry 908b to enable use cases requiring WLAN and BT coexistence. In addition, a switch 903 may be provided between the WLAN FEM circuitry 904a and the BT FEM circuitry 904b to allow switching between the WLAN and BT radios according to application needs. In addition, although the antennas 901 are depicted as being respectively connected to the WLAN FEM circuitry 904a and the BT FEM circuitry 904b, embodiments include within their scope the sharing of one or more antennas as between the WLAN and BT FEMs, or the provision of more than one antenna connected to each of FEM 904a or 904b.

In some embodiments, the front-end module circuitry 904a-b, the radio IC circuitry 906a-b, and baseband processing circuitry 908a-b may be provided on a single radio card, such as wireless radio card 9. In some other embodiments, the one or more antennas 901, the FEM circuitry 904a-b and the radio IC circuitry 906a-b may be provided on a single radio card. In some other embodiments, the radio IC circuitry 906a-b and the baseband processing circuitry 908a-b may be provided on a single chip or integrated circuit (IC), such as IC 912.

In some embodiments, the wireless radio card 902 may include a WLAN radio card and may be configured for Wi-Fi communications, although the scope of the embodiments is not limited in this respect. In some of these embodiments, the radio architecture 900 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 900 may be part of a Wi-Fi communication station (STA) such as a wireless access point (AP), a base station or a mobile device including a Wi-Fi device. In some of these embodiments, radio architecture 900 may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay, 802.11ax and/or 802.11be standards and/or proposed specifications for WLANs, although the scope of embodiments is not limited in this respect. Radio architecture 900 may also be suitable to transmit and/or receive communications in accordance with other techniques and standards.

In some embodiments, the radio architecture 900 may be configured for high-efficiency Wi-Fi (HEW) communications in accordance with the IEEE 802.11ax standard. In these embodiments, the radio architecture 900 may be configured to communicate in accordance with an OFDMA technique, although the scope of the embodiments is not limited in this respect.

In some other embodiments, the radio architecture 900 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 9, the BT baseband circuitry 908b may be compliant with a Bluetooth (BT) connectivity standard such as Bluetooth, Bluetooth 8.0 or Bluetooth 6.0, or any other iteration of the Bluetooth Standard.

In some embodiments, the radio architecture 900 may include other radio cards, such as a cellular radio card configured for cellular (e.g., 3GPP such as LTE, LTE-Advanced or 5G communications).

In some IEEE 802.11 embodiments, the radio architecture 900 may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

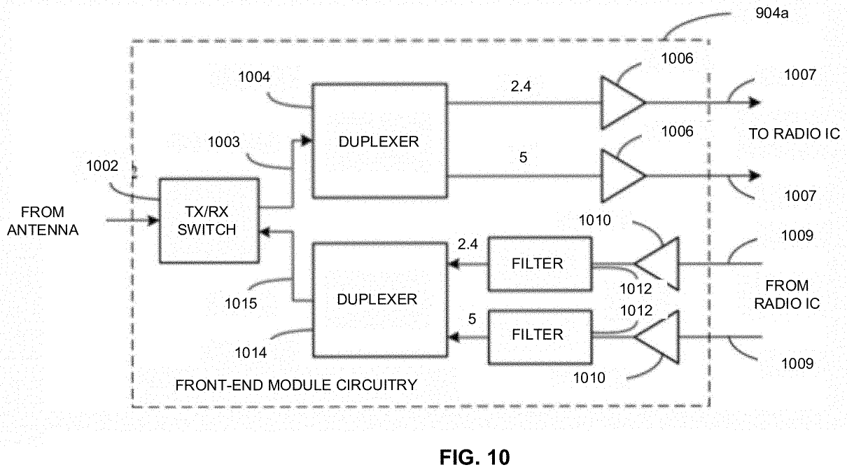

FIG. 10 illustrates WLAN FEM circuitry 904a in accordance with some embodiments. Although the example of FIG. 10 is described in conjunction with the WLAN FEM circuitry 904a, the example of FIG. 10 may be described in conjunction with the example BT FEM circuitry 904b (FIG. 9), although other circuitry configurations may also be suitable.

In some embodiments, the FEM circuitry 904a may include a TX/RX switch 1002 to switch between transmit mode and receive mode operation. The FEM circuitry 904a may include a receive signal path and a transmit signal path. The receive signal path of the FEM circuitry 904a may include a low-noise amplifier (LNA) 1006 to amplify received RF signals 1003 and provide the amplified received RF signals 1007 as an output (e.g., to the radio IC circuitry 906a-b (FIG. 9)). The transmit signal path of the circuitry 904a may include a power amplifier (PA) to amplify input RF signals 1009 (e.g., provided by the radio IC circuitry 906a-b), and one or more filters 1012, such as band-pass filters (BPFs), low-pass filters (LPFs) or other types of filters, to generate RF signals 1015 for subsequent transmission (e.g., by one or more of the antennas 901 (FIG. 9)) via an example duplexer 1014.

In some dual-mode embodiments for Wi-Fi communication, the FEM circuitry 904a may be configured to operate in either the 2.4 GHz frequency spectrum or the 5 GHz frequency spectrum. In these embodiments, the receive signal path of the FEM circuitry 904a may include a receive signal path duplexer 1004 to separate the signals from each spectrum as well as provide a separate LNA 1006 for each spectrum as shown. In these embodiments, the transmit signal path of the FEM circuitry 904a may also include a power amplifier 1010 and a filter 1012, such as a BPF, an LPF or another type of filter for each frequency spectrum and a transmit signal path duplexer 1004 to provide the signals of one of the different spectrums onto a single transmit path for subsequent transmission by the one or more of the antennas 901 (FIG. 9). In some embodiments, BT communications may utilize the 2.4 GHz signal paths and may utilize the same FEM circuitry 904a as the one used for WLAN communications.

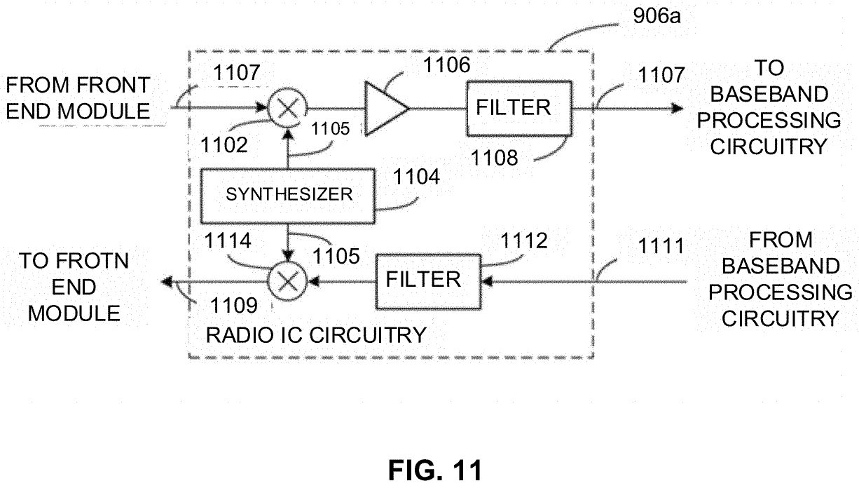

FIG. 11 illustrates radio IC circuitry 906a in accordance with some embodiments. The radio IC circuitry 906a is one example of circuitry that may be suitable for use as the WLAN or BT radio IC circuitry 906a/906b (FIG. 9), although other circuitry configurations may also be suitable. Alternatively, the example of FIG. 11 may be described in conjunction with the example BT radio IC circuitry 906b.

In some embodiments, the radio IC circuitry 906a may include a receive signal path and a transmit signal path. The receive signal path of the radio IC circuitry 906a may include at least mixer circuitry 1102, such as, for example, down-conversion mixer circuitry, amplifier circuitry 1106 and filter circuitry 1108. The transmit signal path of the radio IC circuitry 906a may include at least filter circuitry 1112 and mixer circuitry 1114, such as, for example, up-conversion mixer circuitry. Radio IC circuitry 906a may also include synthesizer circuitry 1104 for synthesizing a frequency 1105 for use by the mixer circuitry 1102 and the mixer circuitry 1114. The mixer circuitry 1102 and/or 1114 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 11 illustrates only a simplified version of a radio IC circuitry, and may include, although not shown, embodiments where each of the depicted circuitries may include more than one component. For instance, mixer circuitry 1114 may each include one or more mixers, and filter circuitries 1108 and/or 1112 may each include one or more filters, such as one or more BPFs and/or LPFs according to application needs. For example, when mixer circuitries are of the direct-conversion type, they may each include two or more mixers.

In some embodiments, mixer circuitry 1102 may be configured to down-convert RF signals 1007 received from the FEM circuitry 904a-b (FIG. 9) based on the synthesized frequency 1105 provided by synthesizer circuitry 1104. The amplifier circuitry 1106 may be configured to amplify the down-converted signals and the filter circuitry 1108 may include an LPF configured to remove unwanted signals from the down-converted signals to generate output baseband signals 1107. Output baseband signals 1107 may be provided to the baseband processing circuitry 908a-b (FIG. 9) for further processing. In some embodiments, the output baseband signals 1107 may be zero-frequency baseband signals, although this is not a requirement. In some embodiments, mixer circuitry 1102 may comprise passive mixers, although the scope of the embodiments is not limited in this respect.

In some embodiments, the mixer circuitry 1114 may be configured to up-convert input baseband signals 1111 based on the synthesized frequency 1105 provided by the synthesizer circuitry 1104 to generate RF output signals 1009 for the FEM circuitry 904a-b. The baseband signals 1111 may be provided by the baseband processing circuitry 908a-b and may be filtered by filter circuitry 1112. The filter circuitry 1112 may include an LPF or a BPF, although the scope of the embodiments is not limited in this respect.

In some embodiments, the mixer circuitry 1102 and the mixer circuitry 1114 may each include two or more mixers and may be arranged for quadrature down-conversion and/or up-conversion respectively with the help of synthesizer 1104. In some embodiments, the mixer circuitry 1102 and the mixer circuitry 1114 may each include two or more mixers each configured for image rejection (e.g., Hartley image rejection). In some embodiments, the mixer circuitry 1102 and the mixer circuitry 1114 may be arranged for direct down-conversion and/or direct up-conversion, respectively. In some embodiments, the mixer circuitry 1102 and the mixer circuitry 1114 may be configured for super-heterodyne operation, although this is not a requirement.

Mixer circuitry 1102 may comprise, according to one embodiment: quadrature passive mixers (e.g., for the in-phase (I) and quadrature phase (Q) paths). In such an embodiment, RF input signal 1007 from FIG. 11 may be down-converted to provide I and Q baseband output signals to be transmitted to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1105 of synthesizer 1104 (FIG. 11). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1007 (FIG. 10) may comprise a balanced signal, although the scope of the embodiments is not limited in this respect. The I and Q baseband output signals may be provided to low-noise amplifier, such as amplifier circuitry 1106 (FIG. 11) or to filter circuitry 1108 (FIG. 11).

In some embodiments, the output baseband signals 1107 and the input baseband signals 1111 may be analog baseband signals, although the scope of the embodiments is not limited in this respect. In some alternate embodiments, the output baseband signals 1107 and the input baseband signals 1111 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1104 may be a fractional-N synthesizer or a fractional N/N+1 synthesizer, although the scope of the embodiments is not limited in this respect as other types of frequency synthesizers may be suitable. For example, synthesizer circuitry 1104 may be a delta-sigma synthesizer, a frequency multiplier, or a synthesizer comprising a phase-locked loop with a frequency divider. According to some embodiments, the synthesizer circuitry 1104 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1104 may be provided by a voltage controlled oscillator (VCO), although that is not a requirement. A divider control input may further be provided by either the baseband processing circuitry 908a-b (FIG. 9) depending on the desired output frequency 1105. In some embodiments, a divider control input (e.g., N) may be determined from a look-up table (e.g., within a Wi-Fi card) based on a channel number and a channel center frequency as determined or indicated by the example application processor 910. The application processor 910 may include, or otherwise be connected to, one of the example security signal converter 101 or the example received signal converter 103 (e.g., depending on which device the example radio architecture is implemented in).

In some embodiments, synthesizer circuitry 1104 may be configured to generate a carrier frequency as the output frequency 1105, while in other embodiments, the output frequency 1105 may be a fraction of the carrier frequency (e.g., one-half the carrier frequency, one-third the carrier frequency). In some embodiments, the output frequency 1105 may be a LO frequency (fLO).

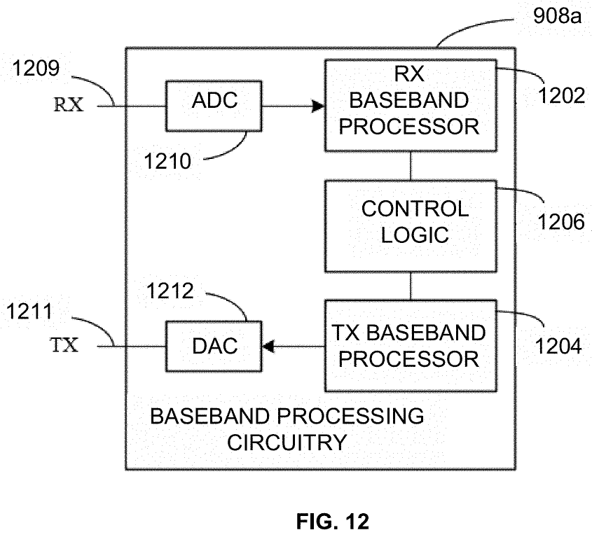

FIG. 12 illustrates a functional block diagram of baseband processing circuitry 908a in accordance with some embodiments. The baseband processing circuitry 908a is one example of circuitry that may be suitable for use as the baseband processing circuitry 908a (FIG. 9), although other circuitry configurations may also be suitable. Alternatively, the example of FIG. 11 may be used to implement the example BT baseband processing circuitry 908b of FIG. 9.

The baseband processing circuitry 908a may include a receive baseband processor (RX BBP) 1202 for processing receive baseband signals 1109 provided by the radio IC circuitry 906a-b (FIG. 9) and a transmit baseband processor (TX BBP) 1204 for generating transmit baseband signals 1111 for the radio IC circuitry 906a-b. The baseband processing circuitry 908a may also include control logic 1206 for coordinating the operations of the baseband processing circuitry 908a.

In some embodiments (e.g., when analog baseband signals are exchanged between the baseband processing circuitry 908a-b and the radio IC circuitry 906a-b), the baseband processing circuitry 908a may include ADC 1210 to convert analog baseband signals 1209 received from the radio IC circuitry 906a-b to digital baseband signals for processing by the RX BBP 1202. In these embodiments, the baseband processing circuitry 908a may also include DAC 1212 to convert digital baseband signals from the TX BBP 1204 to analog baseband signals 1211.

In some embodiments that communicate OFDM signals or OFDMA signals, such as through baseband processor 908a, the transmit baseband processor 1204 may be configured to generate OFDM or OFDMA signals as appropriate for transmission by performing an inverse fast Fourier transform (IFFT). The receive baseband processor 1202 may be configured to process received OFDM signals or OFDMA signals by performing an FFT. In some embodiments, the receive baseband processor 1202 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 9, in some embodiments, the antennas 901 (FIG. 9) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 901 may each include a set of phased-array antennas, although embodiments are not so limited.

Although the radio architecture 900 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The following paragraphs describe examples of various embodiments.

Example 1 includes a method for an Access Point (AP), comprising: encoding a trigger frame in a parameterized spatial reuse reception (PSRR) physical layer (PHY) protocol data unit (PSRR PPDU); and providing the PSRR PPDU for transmission to one or more Stations (STAs), wherein the PSRR PPDU comprising puncture information indicating punctured subchannels of the PSRR PPDU or a normalization factor indicating a number of subchannels occupied by the PSRR PPDU.

Example 2 includes the method of Example 1, wherein the PSRR PPDU comprises a common information field and a first special user information field, and wherein the puncture information or the normalization factor is carried in the common information field and/or the first special user information field.

Example 3 includes the method of Example 1 or 2, wherein the puncture information is carried in 9 bits of the PSRR PPDU comprising 8 reserved bits B56-B63 of the common information field and 1 reserved bit of the first special user information field.

Example 4 includes the method of any of Examples 1-3, wherein the puncture information is carried in any 9 bits of B25-B30 and B32-B39 of the first special user information field.

Example 5 includes the method of any of Examples 1-4, wherein the PSRR PPDU comprises a second special user information field right after a first special user information field in the PSRR PPDU, and wherein the puncture information is carried in the second special user information field.

Example 6 includes the method of any of Examples 1-5, wherein the normalization factor is carried in 4 bits in the PSRR PPDU to indicate a number of 1-16.

Example 7 includes the method of any of Examples 1-6, wherein the normalization factor is carried in any 4 bits of B56-B62 of the common information field in the PSRR PPDU.

Example 8 includes the method of any of Examples 1-7, wherein the normalization factor is carried in bits of B56-B59 of the common information field in the PSRR PPDU.

Example 9 includes the method of any of Examples 1-8, wherein the normalization factor is carried in any 4 bits of B25-B30 or B32-B39 of the first special user information field in the PSRR PPDU.

Example 10 includes the method of any of Examples 1-9, wherein the normalization factor is carried in bits of B25-B28 or B32-B35 of the first special user information field in the PSRR PPDU.

Example 11 includes the method of any of Examples 1-0, wherein the PSRR PPDU is an Extremely High Throughput (EHT) PSRR PPDU.

Example 12 includes a method for a Station (STA), comprising: encoding a trigger-based frame in a Trigger Based (TB) Physical Layer (PHY) Protocol Data Unit (PPDU); and providing the TB PPDU for transmission to an Access Point (AP), wherein the TB PPDU comprising puncture information indicating punctured subchannels of the TB PPDU or a normalization factor indicating a number of subchannels occupied by the TB PPDU.

Example 13 includes the method of Example 12 or 13, wherein the normalization factor is carried in 4 bits in the TB PPDU to indicate a number of 1-16.

Example 14 includes the method of any of Examples 12-13, wherein the TB PPDU comprises a U-SIG field, and wherein the normalization factor is carried in the U-SIG field.

Example 15 includes the method of any of Examples 12-14, wherein the U-SIG field comprise a U-SIG-1 subfield and U-SIG-2 subfield, and wherein the normalization factor is carried in any 4 bits of B20-B25 in the U-SIG-1 subfield or B11-B15 in the U-SIG-2 subfield.

Example 16 includes the method of any of Examples 12-15, wherein the puncture information is encoded in the TB PPDU in a same manner with partial bandwidth information encoded in a NDP announcement frame.

Example 17 includes the method of any of Examples 12-16, wherein the TB PPDU is an Extremely High Throughput (EHT) TB PPDU.

Example 18 includes an apparatus for an Access Point (AP), comprising: interface circuitry; and processor circuitry coupled with the interface circuitry and configured to: encode a trigger frame in a parameterized spatial reuse reception (PSRR) physical layer (PHY) protocol data unit (PSRR PPDU); and provide the PSRR PPDU to the interface circuitry for transmission to one or more Stations (STAs), wherein the PSRR PPDU comprising puncture information indicating punctured subchannels of the PSRR PPDU or a normalization factor indicating a number of subchannels occupied by the PSRR PPDU.

Example 19 includes the apparatus of Example 18, wherein the PSRR PPDU comprises a common information field and a first special user information field, and wherein the puncture information or the normalization factor is carried in the common information field and/or the first special user information field.

Example 20 includes the apparatus of Example 18 or 19, wherein the puncture information is carried in 9 bits of the PSRR PPDU comprising 8 reserved bits B56-B63 of the common information field and 1 reserved bit of the first special user information field.

Example 21 includes the apparatus of any of Examples 18-20, wherein the puncture information is carried in any 9 bits of B25-B30 and B32-B39 of the first special user information field.

Example 22 includes the apparatus of any of Examples 18-21, wherein the PSRR PPDU comprises a second special user information field right after a first special user information field in the PSRR PPDU, and wherein the puncture information is carried in the second special user information field.

Example 23 includes the apparatus of any of Examples 18-22, wherein the normalization factor is carried in 4 bits in the PSRR PPDU to indicate a number of 1-16.

Example 24 includes the apparatus of any of Examples 18-23, wherein the normalization factor is carried in any 4 bits of B56-B62 of the common information field in the PSRR PPDU.

Example 25 includes the apparatus of any of Examples 18-24, wherein the normalization factor is carried in bits of B56-B59 of the common information field in the PSRR PPDU.

Example 26 includes the apparatus of any of Examples 18-25, wherein the normalization factor is carried in 4 bits of B25-B28 or B32-B35 of the first special user information field in the PSRR PPDU.

Example 27 includes the apparatus of any of Examples 18-26, wherein the normalization factor is carried in bits of B25-B28 or B32-B35 of the first special user information field in the PSRR PPDU.

Example 28 includes the apparatus of any of Examples 18-27, wherein the PSRR PPDU is an Extremely High Throughput (EHT) PSRR PPDU.

Example 29 includes an apparatus for a Station (STA), comprising: interface circuitry; and processor circuitry coupled with the interface circuitry and configured to: encode a trigger-based frame in a Trigger Based (TB) Physical Layer (PHY) Protocol Data Unit (PPDU); and provide the TB PPDU to the interface circuitry for transmission to an Access Point (AP), wherein the TB PPDU comprising puncture information indicating punctured subchannels of the TB PPDU or a normalization factor indicating a number of subchannels occupied by the TB PPDU.

Example 30 includes the apparatus of Example 29, wherein the normalization factor is carried in 4 bits in the TB PPDU to indicate a number of 1-16.

Example 31 includes the apparatus of Example 20 or 30, wherein the TB PPDU comprises a U-SIG field, and wherein the normalization factor is carried in the U-SIG field.

Example 32 includes the apparatus of any of Examples 29-31, wherein the U-SIG field comprise a U-SIG-1 subfield and U-SIG-2 subfield, and wherein the normalization factor is carried in any 4 bits of B20-B25 in the U-SIG-1 subfield or B11-B15 in the U-SIG-2 subfield.

Example 33 includes the apparatus of any of Examples 29-32, wherein the puncture information is encoded in the TB PPDU in a same manner with partial bandwidth information encoded in a NDP announcement frame.

Example 34 includes the apparatus of any of Examples 29-33, wherein the TB PPDU is an Extremely High Throughput (EHT) TB PPDU.

Example 35 includes a method for a station (STA), comprising: receiving a trigger frame in a parameterized spatial reuse reception (PSRR) physical layer (PHY) protocol data unit (PSRR PPDU); and decoding the PSRR PPDU for UL transmission based on Parameterized Spatial reuse (PSR) based Spatial Reuse (SR), wherein the PSRR PPDU comprising puncture information indicating punctured subchannels of the PSRR PPDU or a normalization factor indicating a number of subchannels occupied by the PSRR PPDU.

Example 36 includes the method of Examples 35, wherein the PSRR PPDU comprises a common information field and a first special user information field, and wherein the puncture information or the normalization factor is carried in the common information field and/or the first special user information field.

Example 37 includes the method of Example 35 or 36, wherein the puncture information is carried in 9 bits of the PSRR PPDU comprising 8 reserved bits B56-B63 of the common information field and 1 reserved bit of the first special user information field.

Example 38 includes the method of any of Examples 35-37, wherein the puncture information is carried in any 9 bits of B25-B30 and B32-B39 of the first special user information field.

Example 39 includes the method of any of Examples 35-38, wherein the PSRR PPDU comprises a second special user information field right after a first special user information field in the PSRR PPDU, and wherein the puncture information is carried in the second special user information field.

Example 40 includes the method of any of Examples 35-39, wherein the normalization factor is carried in 4 bits in the PSRR PPDU to indicate a number of 1-16.

Example 41 includes the method of any of Examples 35-40, wherein the normalization factor is carried in any 4 bits of B56-B62 of the common information field in the PSRR PPDU.

Example 42 includes the method of any of Examples 35-41, wherein the normalization factor is carried in bits of B56-B59 of the common information field in the PSRR PPDU.

Example 43 includes the method of any of Examples 35-42, wherein the normalization factor is carried in any 4 bits of B25-B30 or B32-B39 of the first special user information field in the PSRR PPDU.

Example 44 includes the method of any of Examples 35-43, wherein the normalization factor is carried in bits of B25-B28 or B32-B35 of the first special user information field in the PSRR PPDU.

Example 45 includes the method of any of Examples 35-44, wherein the PSRR PPDU is an Extremely High Throughput (EHT) PSRR PPDU.

Example 46 includes a method for an Access Point (AP), comprising: receiving a trigger-based frame in a Trigger Based (TB) Physical Layer (PHY) Protocol Data Unit (PPDU); and decoding the TB PPDU, wherein the TB PPDU comprising puncture information indicating punctured subchannels of the TB PPDU or a normalization factor indicating a number of subchannels occupied by the TB PPDU.

Example 47 includes the method of Examples 46, wherein the normalization factor is carried in 4 bits in the TB PPDU to indicate a number of 1-16.

Example 48 includes the method of Example 46 or 47, wherein the TB PPDU comprises a U-SIG field, and wherein the normalization factor is carried in the U-SIG field.

Example 49 includes the method of any of Examples 46-48, wherein the U-SIG field comprise a U-SIG-1 subfield and U-SIG-2 subfield, and wherein the normalization factor is carried in any 4 bits of B20-B25 in the U-SIG-1 subfield or B11-B15 in the U-SIG-2 subfield.

Example 50 includes the method of any of Examples 46-49, wherein the puncture information is encoded in the TB PPDU in a same manner with partial bandwidth information encoded in a NDP announcement frame.

Example 51 includes the method of any of Examples 46-50, wherein the TB PPDU is an Extremely High Throughput (EHT) TB PPDU.

Example 52 includes an apparatus for a Station (STA), comprising: interface circuitry; and processor circuitry coupled with the interface circuitry and configured to: receive a trigger frame in a parameterized spatial reuse reception (PSRR) physical layer (PHY) protocol data unit (PSRR PPDU); and decode the PSRR PPDU for UL transmission based on Parameterized Spatial reuse (PSR) based Spatial Reuse (SR), wherein the PSRR PPDU comprising puncture information indicating punctured subchannels of the PSRR PPDU or a normalization factor indicating a number of subchannels occupied by the PSRR PPDU.

Example 53 includes the apparatus of Examples 52, wherein the PSRR PPDU comprises a common information field and a first special user information field, and wherein the puncture information or the normalization factor is carried in the common information field and/or the first special user information field.

Example 54 includes the apparatus of Example 52 or 53, wherein the puncture information is carried in 9 bits of the PSRR PPDU comprising 8 reserved bits B56-B63 of the common information field and 1 reserved bit of the first special user information field.

Example 55 includes the apparatus of any of Examples 52-54, wherein the puncture information is carried in any 9 bits of B25-B30 and B32-B39 of the first special user information field.

Example 56 includes the apparatus of any of Examples 52-55, wherein the PSRR PPDU comprises a second special user information field right after a first special user information field in the PSRR PPDU, and wherein the puncture information is carried in the second special user information field.

Example 57 includes the apparatus of any of Examples 52-56, wherein the normalization factor is carried in 4 bits in the PSRR PPDU to indicate a number of 1-16.

Example 58 includes the apparatus of any of Examples 52-57, wherein the normalization factor is carried in any 4 bits of B56-B62 of the common information field in the PSRR PPDU.

Example 59 includes the apparatus of any of Examples 52-58, wherein the normalization factor is carried in bits of B56-B59 of the common information field in the PSRR PPDU.

Example 60 includes the apparatus of any of Examples 52-59, wherein the normalization factor is carried in 4 bits of B25-B28 or B32-B35 of the first special user information field in the PSRR PPDU.

Example 61 includes the apparatus of any of Examples 52-60, wherein the normalization factor is carried in bits of B25-B28 or B32-B35 of the first special user information field in the PSRR PPDU.

Example 62 includes the apparatus of any of Examples 52-61, wherein the PSRR PPDU is an Extremely High Throughput (EHT) PSRR PPDU.

Example 63 includes an apparatus for an Access Point (AP), comprising: interface circuitry; and processor circuitry coupled with the interface circuitry and configured to: receive a trigger-based frame in a Trigger Based (TB) Physical Layer (PHY) Protocol Data Unit (PPDU); and decode the TB PPDU, wherein the TB PPDU comprising puncture information indicating punctured subchannels of the TB PPDU or a normalization factor indicating a number of subchannels occupied by the TB PPDU.

Example 64 includes the apparatus of Examples 63, wherein the normalization factor is carried in 4 bits in the TB PPDU to indicate a number of 1-16.

65. Example 65 includes the apparatus of Example 63 or 64, wherein the TB PPDU comprises a U-SIG field, and wherein the normalization factor is carried in the U-SIG field.

Example 66 includes the apparatus of any of Examples 63-65, wherein the U-SIG field comprise a U-SIG-1 subfield and U-SIG-2 subfield, and wherein the normalization factor is carried in any 4 bits of B20-B25 in the U-SIG-1 subfield or B11-B15 in the U-SIG-2 subfield.

Example 67 includes the apparatus of any of Examples 63-66, wherein the puncture information is encoded in the TB PPDU in a same manner with partial bandwidth information encoded in a NDP announcement frame.

Example 68 includes the apparatus of any of Examples 63-67, wherein the TB PPDU is an Extremely High Throughput (EHT) TB PPDU.

Example 69 includes a computer-readable medium having instructions stored thereon, wherein the instructions, when executed by processor circuitry of an Access Point (AP), cause the processor circuitry to perform the method of any of Examples 1-11.

Example 70 includes an apparatus for an Access Point (AP) comprising means for performing the actions of the method of any of Examples 1-11.

Example 71 includes a computer-readable medium having instructions stored thereon, wherein the instructions, when executed by processor circuitry of a Station (STA), cause the processor circuitry to perform the method of any of Examples 12-17.

Example 72 includes an apparatus for a Station (STA), comprising means for performing the actions of the method of any of Examples 12-17.

Example 73 includes a computer-readable medium having instructions stored thereon, wherein the instructions, when executed by processor circuitry of a Station (STA), cause the processor circuitry to perform the method of any of Examples 35-45.

Example 74 includes an apparatus for a Station (STA) comprising means for performing the actions of the method of any of Examples 35-45.

Example 75 includes a computer-readable medium having instructions stored thereon, wherein the instructions, when executed by processor circuitry of an Access Point (AP), cause the processor circuitry to perform the method of any of Examples 46-51.

Example 76 includes an apparatus for an Access Point (AP), comprising means for performing the actions of the method of any of Examples 46-51.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. An apparatus for an Access Point (AP), comprising:
interface circuitry; and
processor circuitry coupled with the interface circuitry and configured to:
encode a trigger frame in a parameterized spatial reuse reception (PSRR) physical layer (PHY) protocol data unit (PSRR PPDU); and
provide the PSRR PPDU to the interface circuitry for transmission to one or more Stations (STAs),
wherein the PSRR PPDU comprising puncture information indicating punctured subchannels of the PSRR PPDU or a normalization factor indicating a number of subchannels occupied by the PSRR PPDU.

2. The apparatus of claim 1, wherein the PSRR PPDU comprises a common information field and a first special user information field, and wherein the puncture information or the normalization factor is carried in the common information field and/or the first special user information field.

3. The apparatus of claim 2, wherein the puncture information is carried in 9 bits of the PSRR PPDU comprising 8 reserved bits B56-B63 of the common information field and 1 reserved bit of the first special user information field.

4. The apparatus of claim 2, wherein the puncture information is carried in any 9 bits of B25-B30 and B32-B39 of the first special user information field.

5. The apparatus of claim 1, wherein the PSRR PPDU comprises a second special user information field right after a first special user information field in the PSRR PPDU, and wherein the puncture information is carried in the second special user information field.

6. The apparatus of claim 2, wherein the normalization factor is carried in 4 bits in the PSRR PPDU to indicate a number of 1-16.

7. The apparatus of claim 6, wherein the normalization factor is carried in any 4 bits of B56-B62 of the common information field in the PSRR PPDU.

8. The apparatus of claim 6, wherein the normalization factor is carried in bits of B56-B59 of the common information field in the PSRR PPDU.

9. The apparatus of claim 6, wherein the normalization factor is carried in 4 bits of B25-B28 or B32-B35 of the first special user information field in the PSRR PPDU.

10. The apparatus of claim 6, wherein the normalization factor is carried in bits of B25-B28 or B32-B35 of the first special user information field in the PSRR PPDU.

11. The apparatus of claim 1, wherein the PSRR PPDU is an Extremely High Throughput (EHT) PSRR PPDU.

12. An apparatus for a Station (STA), comprising:
interface circuitry; and
processor circuitry coupled with the interface circuitry and configured to:
encode a trigger-based frame in a Trigger Based (TB) Physical Layer (PHY) Protocol Data Unit (PPDU); and
provide the TB PPDU to the interface circuitry for transmission to an Access Point (AP),
wherein the TB PPDU comprising puncture information indicating punctured subchannels of the TB PPDU or a normalization factor indicating a number of subchannels occupied by the TB PPDU.

13. The apparatus of claim 12, wherein the normalization factor is carried in 4 bits in the TB PPDU to indicate a number of 1-16.

14. The apparatus of claim 13, wherein the TB PPDU comprises a U-SIG field, and wherein the normalization factor is carried in the U-SIG field.

15. The apparatus of claim 14, wherein the U-SIG field comprise a U-SIG-1 subfield and U-SIG-2 subfield, and wherein the normalization factor is carried in any 4 bits of B20-B25 in the U-SIG-1 subfield or B11-B15 in the U-SIG-2 subfield.

16. The apparatus of claim 12, wherein the puncture information is encoded in the TB PPDU in a same manner with partial bandwidth information encoded in a NDP announcement frame.

17. The apparatus of claim 12, wherein the TB PPDU is an Extremely High Throughput (EHT) TB PPDU.

18. A method for an Access Point (AP), comprising:
encoding a trigger frame in a parameterized spatial reuse reception (PSRR) physical layer (PHY) protocol data unit (PSRR PPDU); and
providing the PSRR PPDU for transmission to one or more Stations (STAs),
wherein the PSRR PPDU comprising puncture information indicating punctured subchannels of the PSRR PPDU or a normalization factor indicating a number of subchannels occupied by the PSRR PPDU.

19. The method of claim 18, wherein the PSRR PPDU comprises a common information field and a first special user information field, and wherein the puncture information or the normalization factor is carried in the common information field and/or the first special user information field.

20. The method of claim 19, wherein the puncture information is carried in 9 bits of the PSRR PPDU comprising 8 reserved bits B56-B63 of the common information field and 1 reserved bit of the first special user information field.

21. The method of claim 19, wherein the puncture information is carried in any 9 bits of B25-B30 and B32-B39 of the first special user information field.

22. The method of claim 18, wherein the PSRR PPDU comprises a second special user information field right after a first special user information field in the PSRR PPDU, and wherein the puncture information is carried in the second special user information field.

23. The method of claim 19, wherein the normalization factor is carried in 4 bits in the PSRR PPDU to indicate a number of 1-16.

24. The method of claim 23, wherein the normalization factor is carried in any 4 bits of B56-B62 of the common information field in the PSRR PPDU.

25. The method of claim 23, wherein the normalization factor is carried in any 4 bits of B25-B30 or B32-B39 of the first special user information field in the PSRR PPDU.
